(19) United States
(12) Patent Application Publication
(10) Pub. No.: US 2008/0228535 A1
(43) Pub. Date: Sep. 18, 2008

(54) Information Handling System Deployment Assessment

(76) Inventors: Kevin Hanes, Round Rock, TX (US); Gregory Bomsta, Austin, TX (US); Stephen Oates, Georgetown, TX (US); Jefferson Raley, Austin, TX (US)

Correspondence Address: HAMILTON & TERRILE, LLP, P.O. BOX 203518, AUSTIN, TX, 78720, US

(21) Appl. No.: 11/685,389

(22) Filed: Mar. 13, 2007

(51) Int. Cl. G06F 9/44

(52) U.S. Cl. 705/7; 705/10

(57) ABSTRACT

A client deployment assessment tool which provides a structured approach to evaluating a customer's information handling system deployment processes and tools. The client deployment assessment tool accurately estimates costs and shows how an information handling system provider could reduce those costs.

### CROSS REFERENCE TO RELATED APPLICATION

This application relates to co-pending U.S. patent application Ser. No. ______, attorney docket number DC-12038, filed on an even date herewith, entitled “Client Deployment Optimization Mode,” naming Kevin Hanes, Steven Bodnar, Stephen Oates, Jefferson Raley and Gregory Bomsta as inventors, which is incorporated herein by reference in its entirety.

This application relates to co-pending U.S. patent application Ser. No. ______, attorney docket number DC-12042, filed on an even date herewith, entitled “Method to Determine Software Rationalization for Optimizing Information Handling System Deployments,” naming Jefferson Raley, Gregory Bomsta, Kevin Hanes, Stephen Oates and Kurt Stonecipher as inventors, which is incorporated herein by reference in its entirety.

This application relates to co-pending U.S. patent application Ser. No. ______, attorney docket number DC-12152, filed on an even date herewith, entitled “Optimized Deployment Solution,” naming Stephen Oates, Kevin Hanes, Marc Jarvis and Jefferson Raley as inventors, which is incorporated herein by reference in its entirety.

### BACKGROUND OF THE INVENTION

1. Field of the Invention

The present invention relates to providing information handling system services and more particularly to information handling system deployment assessment.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

With the proliferation of information handling systems, especially within large scale information handling system installations, an important issue relates to the service and support of the large scale information handling system installations (i.e., installations in which more than a few information handling systems are supported by a single entity). The large scale information handling system installation provides an information handling system environment.

One issue relating to the service and support of information handling system installation relates to estimating costs associated with deploying information handling systems. Often, the costs associated with deploying an information handling systems can be as much as or greater than the cost of the information handling system.

It would be desirable to provide a structured approach to evaluating a customer's information handling system deployment processes and tools. It is also desirable that such a structured approach be able accurately estimate costs and show how an information handling system provider could reduce those costs.

### SUMMARY OF THE INVENTION

In accordance with the present invention, a client deployment assessment tool is set forth which provides a structured approach to evaluating a customer's information handling system deployment processes and tools. The client deployment assessment tool accurately estimates costs and shows how an information handling system provider could reduce those costs.

More specifically, the client deployment assessment tool functions as a multi-week engagement (e.g., four to six weeks) between a customer and an information handling system provider. The client deployment assessment uses as inputs cost drivers that are associated with an information handling system deployment based upon many customer experiences across multiple industries. The client deployment assessment uses a deployment optimization model to identify and categorize the cost drivers.

The client deployment assessment uses cost modeling methodologies and tools. The cost modeling methodologies and tools approximate a customer's actual cost to deploy an information handling system. The cost modeling is combined with information from the many customer experiences to precisely approximate a customer's costs.

In certain embodiments, the client deployment assessment tool includes a survey portion. The survey portion makes use of a set of customer surveys which when completed by the customer provides a set of data from which the customers costs can be approximated. Additionally, in certain embodiments, the client deployment assessment tool includes an interview guide portion which details the organizations, roles, and questions to ask during onsite visits with the customer. Additionally, in certain embodiments, the client deployment assessment tool includes deliverable templates portion. The deliverables template portion includes a set of standardized templates for delivering all phases of the assessment. Additionally, in certain embodiments, the client deployment assessment tool include a rationalization portion, the software rationalization portion generates software rationalization reports that recommend opportunities for reducing software management costs.

More specifically, in one embodiment, the invention relates to a method for assessing information handling systems deployment needs of a customer which includes gathering data from the customer regarding deployment issues, comparing the data from the customer with generalized deployment data based upon information derived from deployment experiences of customers from multiple deployments, and generating, via an information handling system, a deployment report based upon the comparison.

In another embodiment, the invention relates to an apparatus for assessing information handling systems deployment needs of a customer which includes means for gathering data from the customer regarding deployment issues, means for comparing the data from the customer with generalized deployment data based upon information derived from deployment experiences of customers from multiple deployments, and means for generating, via an information handling system, a deployment report based upon the comparison.

In another embodiment, the invention relates to an information handling system which includes a processor and memory coupled to the processor. The memory stores a module for assessing information handling systems deployment needs of a customer. The module comprises instructions for gathering data from the customer regarding deployment issues, comparing the data from the customer with generalized deployment data based upon information derived from deployment experiences of customers from multiple deployments, and generating, via an information handling system, a deployment report based upon the comparison.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a system block diagram of an information handling system on which the deployment and evaluation tool is executed.

FIG. 2 shows a block diagram of a deployment and evaluation tool.

FIG. 3 shows a flow diagram of the operation of the deployment and evaluation tool.

FIG. 4 shows a block diagram of the various stages of the client deployment assessment tool.

FIG. 5 shows a block diagram of some of the issues associated with the interview guide portion of the client deployment assessment tool.

FIG. 6 shows a block diagram of a schedule overview of the client deployment assessment tool.

### DETAILED DESCRIPTION

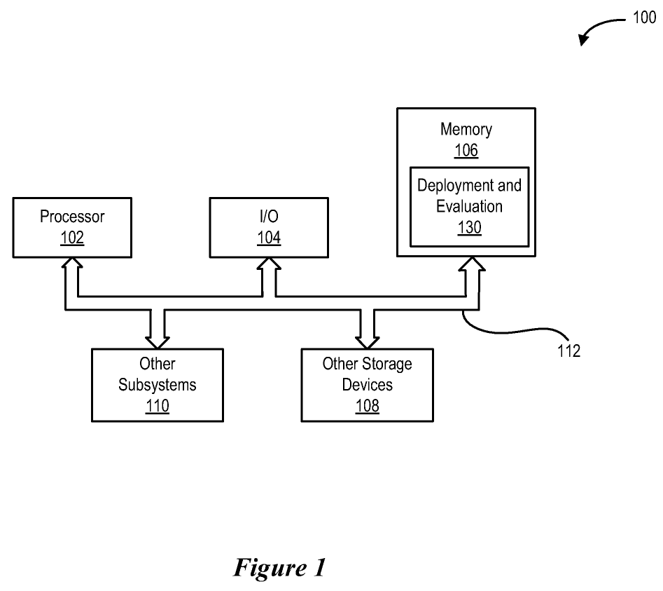

Referring to FIG. 1, a system block diagram of an information handling system 100 on which the deployment and evaluation tool is executed is shown. The information handling system 100 includes a processor 102, input/output (I/O) devices 104, such as a display, a keyboard, a mouse, and associated controllers, a memory 106 including non volatile memory such as a hard disk drive and volatile memory such as random access memory (RAM), and other storage devices 108, such as an optical disk and drive and other memory devices, and various other subsystems 110, all interconnected via one or more buses 112. A deployment and evaluation tool 130 is stored on the memory 106 and executed by the processor 102.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

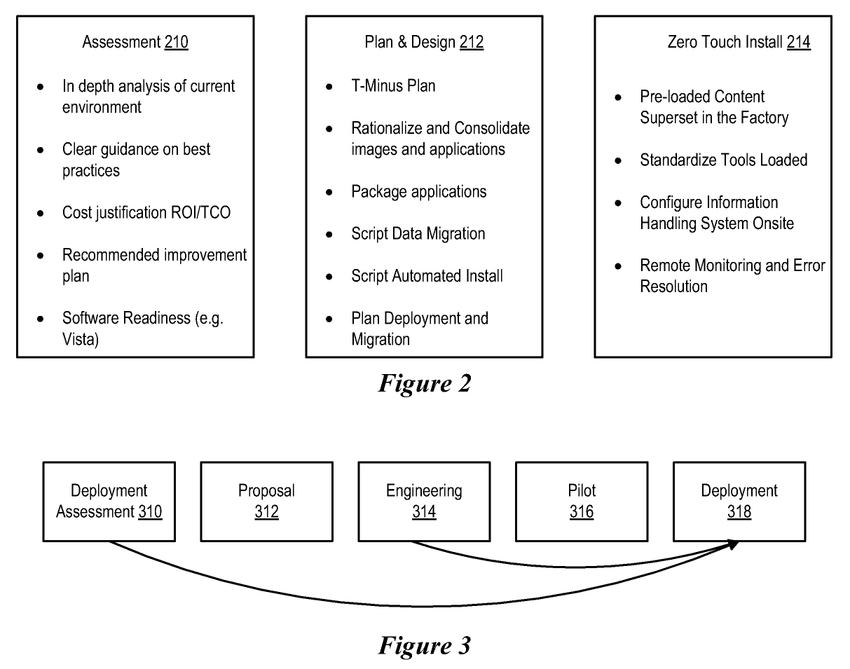

Referring to FIG. 2 a block diagram of the deployment and evaluation tool 130 is shown. More specifically, the deployment and evaluation tool 130 includes an assessment portion 210, a plan & design portion 212 and a zero touch install portion 214.

The assessment portion 210 provides an in depth analysis of a current customer information handling system environment. The assessment portion 210 also provides clear guidance to the customer regarding information handling system environment best practices. The assessment portion 210 also provides support for a deployment cost justification, both with respect to a deployment return on investment (ROI) and total cost to deploy the information handling system (TCO). The assessment portion 210 also provides a recommended improvement plan for a customer information handling system environment. The assessment portion 210 also determines a software readiness of a current customer information handling system environment. The software readiness can determine, for example, the readiness of a current customer information handling system environment to effectively execute a new operating system such as the Microsoft Vista Operating System.

The plan & design portion 212 develops a recommended readiness (T-Minus) plan. The plan & design portion 212 also rationalizes and consolidates images and applications for install onto information handling systems that are to be deployed. The plan & design portion 212 also packages applications for the information handling systems being deployed. The plan & design portion 212 also develops a script data migration for the information handling systems being deployed. The plan & design portion 212 also develops an automated script install for the information handling systems being deployed. The plan & design portion 212 also develops a plan for the deployment and migration of the information handling system environment.

The zero touch install portion 214 generates a content superset for the content that is to be preloaded onto the information handling system and installs the content superset onto the information handling systems being deployed. The zero touch install portion 214 also develops and standardizes tools that are loaded onto the information handling system being deployed. The zero touch install portion 214 also enables onsite configuration of the deployed information handling systems. The zero touch install portion 214 also provides for remote monitoring and error resolution of deployed information handling systems.

Referring to FIG. 3, a flow diagram of the operation of the deployment tool 130 is shown. More specifically, the deployment and evaluation tool 130 begins operation by performing a deployment assessment at step 310. A proposal for an information handling system deployment environment is then developed at step 312. Once the proposal is accepted, engineering to develop the information handling system deployment environment is performed at step 314. Next, a pilot of the information handling system deployment environment is deployed at step 316. Next the information handling system deployment environment is deployed at step 318.

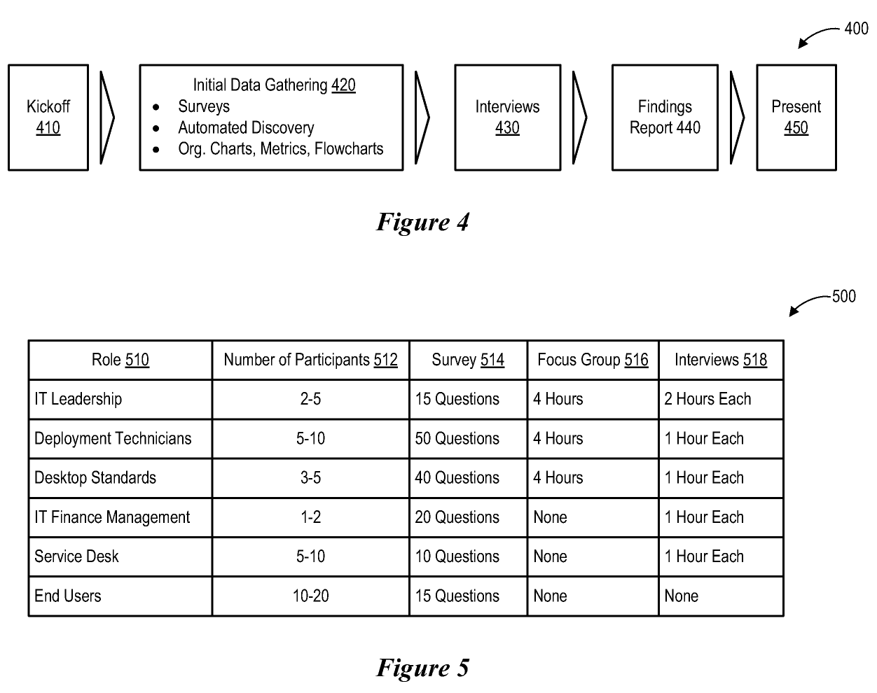

Referring to FIG. 4, a block diagram of the various stages of the client deployment assessment tool is shown. More specifically, the client deployment assessment tool 400 starts operation with an initial kickoff 410. The initial kickoff 410 starts when an agreement is reached between a customer and an information handling system provider that a deployment assessment is desired by the customer. After the initial kickoff, the deployment assessment tool progresses to an initial data gather stage 420. During the initial data gathering stage 420, surveys are distributed, automated discovery of a customer present information handling system deployment environment is generated and data about the customer is gathered. The data can include customer organization charts, customer metrics as well as customer deployment environment flowcharts. The data can also include data obtained by using a deployment optimization model such as that described in the copending application entitled “Client Deployment Optimization Model.” After the initial data gathering stage 420, the interview portion of the client deployment assessment tool 400 starts. After the interview portion of the client deployment assessment tool completes, the client deployment assessment tool 400 generates a findings report at step 440 and presents the report to the customer at step 450.

Referring to FIG. 5, a block diagram of a portion of the interview guide portion 500 of the client deployment assessment tool 400 is shown. More specifically, as part of the interview guide portion 500, various roles 510 are identified within a customer organization. For each of these roles, a number of participants is suggested 512 as well as a particular survey 514. Each role also includes a suggested time 516 for a focus group discussion as well as a suggested interview time 518. For example, for the role of information technology leadership, a suggested number of participants is 2-5 with a survey that includes 15 questions. For the role of information technology leadership, a focus group discussion of four hours is suggested and interviews for the individuals would take approximately two hours each.

With the interview guide portion 500, the numbers of participants for each of the roles as well as the survey used, the focus group time and the interview times are tailored to provide a precise and meaningful deployment assessment.

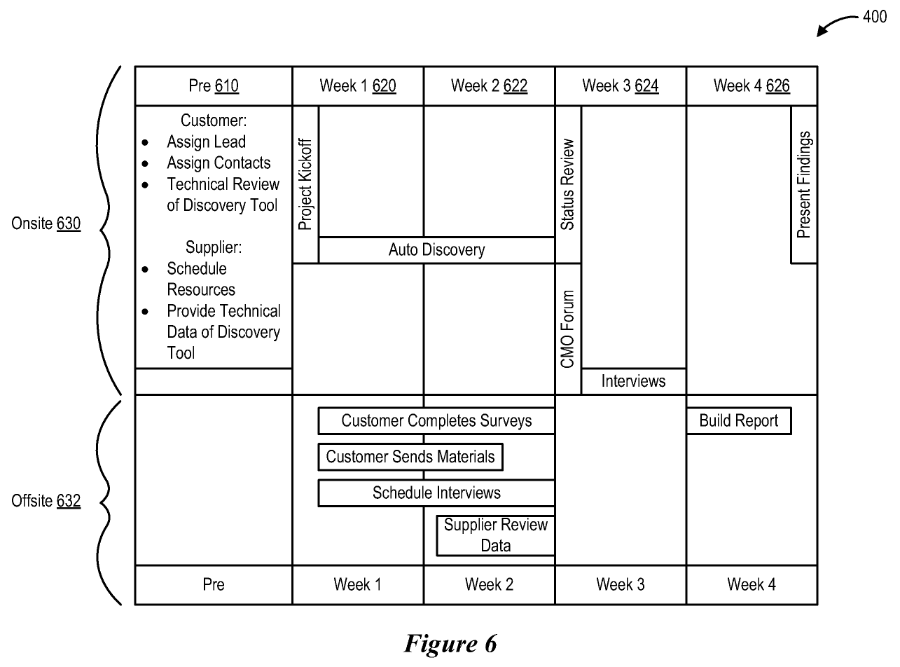

Referring to FIG. 6, a block diagram of a schedule overview of the client deployment assessment tool 400 is shown. More specifically, the operation of the client deployment assessment tool 400 is divided into a plurality of stages where some of the stages can correspond to specific amounts of time. In one embodiment, the client deployment assessment tool 400 includes a preparation stage 610 as well as a plurality of timed stages 412 (e.g., week 1 620, week 2 622, week 3 624 and week 4 626. Additionally, the operation of the client deployment assessment tool includes an onsite operation portion 630 and an offsite operation portion 632.

During the preparation stage 610, the customer performs certain tasks and the information handling system supplier performs certain tasks. More specifically, the customer assigns an IT lead to the deployment project, assigns contacts at various levels of the deployment project and performs a technical review of the discovery tool. The information handling system supplier schedules resources and provides technical data to the discovery tool. These tasks are generally performed at the customers location (i.e., onsite).

During the first timed stage 612 (e.g., week 1 620) the project kickoff occurs and the deployment assessment tool starts the automatic discovery process. The automatic discovery process utilizes off-the-shelf software tools (such as Assetmetrix, ACT or Managesoft) to inventory the customer's information handling hardware and software. This is an optional aspect of the process that is not always performed. Additionally, during the first timed stage, the customer begins completing the surveys provided by the supplier, the customer provides materials regarding its information handling system deployment environment to the supplier and the supplier starts scheduling interviews with the customer contacts provided by the customer corresponding to the interview guide of the deployment assessment tool 400. The project kickoff and the automatic discovery process are performed onsite. The survey completion, provision of materials and interview scheduling can occur at a location other than on the customer premises (i.e., offsite).

During the second time stage 612 (e.g., week 2 622), the automatic discovery process continues. Additionally, the survey completion, provision of materials and interview scheduling continues. As information is received by the supplier, the supplier begins reviewing the received information and the client deployment assessment tool 400 begins processing this information.

During the third timed stage 612 (e.g., week 3 624), the supplier provides a status review for the customer and the supplier generates a current mode of operations (CMO) forum in which detailed time and task data is collected. Additionally, the supplier performs the interviews corresponding to the interview guide of the deployment assessment tool. The status review and generation of the CMO form as well as the interviews are performed onsite.

During the forth times stage 612, (e.g., week 4 626), the deployment assessment tool 400 assimilates all of the information acquired throughout the previous stages and automatically builds a deployment report. The deployment report is unique to the customer's deployment needs based upon the various information that is acquired throughout the assessment process. The deployment report is then presented to the customer to complete the deployment assessment process.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, while certain guidelines are disclosed within the interview guide, variations within the interview guide are contemplated.

Also for example, while the deployment assessment schedule is shown divided into a plurality of weeks, it will be appreciated that other time segments may be used. Additionally, it will be appreciated that each of the stages need not necessarily be equal

Also, for example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or DVDs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for assessing information handling systems deployment needs of a customer comprising
gathering data from the customer regarding deployment issues;
comparing the data from the customer with generalized deployment data, the generalized deployment data being based upon information derived from deployment experiences of customers from multiple deployments; and,
generating, via an information handling system, a deployment report based upon the comparing.

2. The method of claim 1, wherein
the gathering includes conducting interviews of the customer; and,
the conducting interviews is according to a predefined interview guide.

3. The method of claim 2, wherein
the predefined interview guide sets forth roles of individuals to interview.

4. The method of claim 2, wherein
the predefined interview guide sets forth a recommended number of participants to interview.

5. The method of claim 2, wherein
the predefined interview guide sets forth a predefined survey to conduct during the interview.

6. The method of claim 2, wherein
the predefined interview guide sets forth a prescribed length of time for the interview.

7. The method of claim 1, wherein
the gathering includes using a deployment optimization model to identify and categorize the deployment issues.

8. The method of claim 1, wherein
the generating includes generating a set of standardized templates for assessing all phases of the deployment.

9. An apparatus method for assessing information handling systems deployment needs of a customer comprising
means for gathering data from the customer regarding deployment issues;
means for comparing the data from the customer with generalized deployment data, the generalized deployment data being based upon information derived from deployment experiences of customers from multiple deployments; and,
means for generating, via an information handling system, a deployment report based upon the comparing.

10. The apparatus of claim 9, wherein
the means for gathering includes means for conducting interviews of the customer; and,
the means for conducting interviews is according to a predefined interview guide.

11. The apparatus of claim 10, wherein
the predefined interview guide sets forth roles of individuals to interview.

12. The apparatus of claim 10, wherein
the predefined interview guide sets forth a recommended number of participants to interview.

13. The apparatus of claim 10, wherein
the predefined interview guide sets forth a predefined survey to conduct during the interview.

14. The apparatus of claim 10, wherein
the predefined interview guide sets forth a prescribed length of time for the interview.

15. The apparatus of claim 9, wherein
the means for gathering includes a deployment optimization model to identify and categorize the deployment issues.

16. The apparatus of claim 8, wherein
the means for generating includes means for generating a set of standardized templates for assessing all phases of the deployment.

17. An information handling system comprising:
a processor;
memory coupled to the processor, the memory storing a module for assessing information handling systems deployment needs of a customer, the module comprising instructions for gathering data from the customer regarding deployment issues;
comparing the data from the customer with generalized deployment data, the generalized deployment data being based upon information derived from deployment experiences of customers from multiple deployments; and,
generating, via an information handling system, a deployment report based upon the comparing.

18. The information handling system of claim 17, wherein the gathering includes conducting interviews of the customer; and, the conducting interviews is according to a predefined interview guide.

19. The information handling system of claim 18, wherein the predefined interview guide sets forth roles of individuals to interview.

20. The information handing system of claim 18, wherein the predefined interview guide sets forth a recommended number of participants to interview.

21. The information handling system of claim 18, wherein the predefined interview guide sets forth a predefined survey to conduct during the interview.

22. The information handling system of claim 18, wherein the predefined interview guide sets forth a prescribed length of time for the interview.

23. The information handling system of claim 17, wherein the means for gathering includes a deployment optimization model to identify and categorize the deployment issues.

24. The information handling system of claim 17, wherein the generating includes generating a set of standardized templates for assessing all phases of the deployment.
